(19) United States
(12) Patent Application Publication
(10) Pub. No.: US 2024/0429634 A1
(43) Pub. Date: Dec. 26, 2024

(54) ELECTRIFIED VEHICLE BATTERY COMBINATION ELECTRICAL/ FLUID CONNECTOR

(71) Applicant: Ford Global Technologies, LLC, Dearborn, MI (US)

(72) Inventors: Matthew METZLER, Broomfield, CO (US); Thomas J. COUPAR, Ann Arbor, MI (US); James George GEBBIE, Rochester Hills, MI (US); Hao WU, Northville, MI (US); Thomas P. BRACKETT, Dearborn, MI (US)

(73) Assignee: Ford Global Technologies, LLC, Dearborn, MI (US)

(21) Appl. No.: 18/338,918

(22) Filed: Jun. 21, 2023

(51) Int. Cl. H01R 13/00; H01M 10/625; H01M 10/6556; H01M 50/505; H01M 50/509; H01R 13/621

(52) U.S. Cl. CPC H01R 13/005; H01M 10/625; H01M 10/6556; H01M 50/505; H01M 50/509; H01R 13/6215; H01M 2220/20; H01R 2201/26

(57) ABSTRACT

An electrified vehicle system includes a battery having a plurality of cells electrically connected in at least one cell array, the at least one cell array connected to an internal battery busbar within a housing, an annular coolant fitting having a coolant channel extending between an outer radius and an inner radius of the fitting, and an electrically conductive fastener having a closed end and a channel extending from an open end to a radial opening, the fastener extending through the annular coolant fitting with the radial opening positioned within the annular coolant fitting, and further extending through the housing and mechanically and electrically connecting an external busbar outside the housing to the internal busbar, and facilitating coolant flow through the battery array.

### TECHNICAL FIELD

This disclosure relates to a combination electrical/fluid connector coupling an electrical system and cooling system to an immersion cooled battery, such as used in various electrified vehicles.

### BACKGROUND

Electrified vehicles such as battery-electric vehicles (BEVs), plug-in-hybrid-electric vehicles (PHEVs) and hybrid electric vehicles (HEVs) include a high voltage traction battery or battery pack that operates as an energy store for one or more electric machines that provide propulsive torque to vehicle wheels. Immersion cooling of a high voltage battery pack as used in many electrified vehicles involves direct contact of a dielectric cooling fluid with the battery cells of the battery pack. Electrical distribution system (EDS) components can generate heat, especially at connection points due to contact resistances. As such, it may be desirable in various applications to use the immersion cooling fluid to cool these EDS components as well as the battery cells.

### SUMMARY

In one or more embodiments, an electrified vehicle system includes a battery having a plurality of cells electrically connected in at least one cell array having a housing, the at least one cell array connected to an internal busbar within the housing, an annular coolant fitting having a coolant channel extending between an outer radius and an inner radius of the fitting, and an electrically conductive fastener having a closed end and a channel extending from an open end to a radial opening, the fastener extending through the annular coolant fitting with the radial opening positioned within the annular coolant fitting, and further extending through the housing and mechanically and electrically connecting an external busbar to the internal busbar. The fastener may be implemented by a bolt having a threaded region extending below the radial opening and a nut engaging the threaded region, the bolt and nut clamping the external busbar, the annular coolant fitting, and the internal busbar to the housing. The electrified vehicle system may further include an electrically conductive washer disposed between the bolt and the external busbar, an upper washer disposed between the external busbar and the annular coolant fitting, and a lower washer disposed between the annular coolant fitting and the housing.

In one or more embodiments, the electrified vehicle system includes a first cell array and a second cell array, wherein the first and second cell arrays are electrically and fluidly connected in series. In one or more embodiments, the at least one cell array includes a first cell array and a second cell array electrically and fluidly connected in parallel. In other embodiments, the at least one cell array includes first and second cell arrays electrically connected in series and fluidly connect in parallel. In other embodiments, the at least one cell array includes a first cell array and a second cell array electrically connected in parallel and fluidly connected in series.

Embodiments may also include an electrified vehicle including a traction battery having a plurality of cells connected in each of a plurality of arrays connected by an internal busbar within a housing, an electric machine powered by the traction battery and configured to provide propulsive torque to vehicle wheels, a cooling system, and a connector electrically connecting an external busbar to the internal busbar and fluidly connecting the cooling system to at least one of the plurality of arrays of battery cells of the traction battery. In one or more embodiments, the connector is implemented by an electrically conductive fastener having a closed end and a channel extending from an open end to a radial opening fluidly coupled to the cooling system, the fastener extending through the housing and mechanically and electrically connecting the external busbar to the internal busbar and fluidly coupling the plurality of arrays to the cooling system. The connector ma include an annular coolant fitting having a coolant channel extending between an outer radius and an inner radius of the fitting, wherein the fastener extends through the annular coolant fitting with the radial opening disposed within the annular coolant fitting.

In one or more embodiments, the connector may be implemented by tubing surrounding a stranded electrical conductor and configured to contain a dielectric coolant, an end cap connected to the tubing and having a plurality of openings configured to facilitate coolant flow therethrough, a central opening configured to accommodate the stranded electrical conductor, and a fitting secured to the tubing and configured to engage a complementary housing fitting. The connector may also include a spade connector or a pin connector connected to the stranded electrical conductor.

Embodiments may include the plurality of arrays electrically and fluidly connected in parallel, or electrically and fluidly connected in series. In other embodiments, the plurality of arrays are either electrically connected in series and fluidly connected in parallel, or electrically connected in parallel and fluidly connected in series.

In one or more embodiments, a combination electrical and fluid connector may include an electrically conductive bolt having a closed end, a channel extending from an open end to a radial opening, and a threaded portion extending from the open end toward the radial opening, and an annular coolant fitting having a coolant channel extending between an outer radius and an inner radius of the fitting, the bolt extending through the annular coolant fitting with the radial opening positioned within the annular coolant fitting, and further extending through a housing of a battery mechanically and electrically connecting an external busbar to an internal busbar of the battery, and facilitating coolant flow through the battery. The connector may further include a conductive washer disposed between the conductive bolt and the annular coolant fitting. The connector may also include a threaded nut engaging the threaded portion of the bolt and clamping the external busbar, the annular coolant fitting, and the internal busbar to the housing. The connector may also include an upper washer disposed between the external busbar and the annular coolant fitting and a lower washer disposed between the annular coolant fitting and the housing.

One or more embodiments according to the disclosure may have associated advantages. Various prior art strategies for immersion cooling of the cells utilize separate electric and fluid connections into the array that must be sealed against the pressurized fluid. In contrast, the combined electrical and fluid connection design according to various embodiments allows the cooling of the battery cells and electrical distribution system connection points while using the same number or a fewer number of fluid seals at the array housing. Those of ordinary skill in the art may recognize additional advantages of one or more embodiments for particular applications or implementations that are not explicitly stated based on the teachings of the disclosure.

### BRIEF DESCRIPTION OF THE DRAWINGS

FIG. 1 is a block diagram of an electrified vehicle including a combination electrical/fluid connector coupling battery cell arrays of a traction battery according to the disclosure;

FIG. 2A illustrates a pin connector embodiment of a combination electrical/fluid connector.

FIG. 2B illustrates a spade connector embodiment of a combination electrical/fluid connector.

FIG. 2C and FIG. 2D illustrate a combination electrical/fluid cabling and associated endcap for an electrical/fluid connector.

FIG. 3 illustrates a combination electrical/fluid connection of a battery cell array with a banjo fitting.

FIG. 4 is a block diagram illustrating battery cell arrays electrically and fluidly connected in series using combination electrical/fluid connectors.

FIG. 5 is a block diagram illustrating battery cell arrays electrically and fluidly connected in parallel using combination electrical/fluid connectors.

FIG. 6 is a block diagram illustrating battery cell arrays electrically connected in series and fluidly connected in parallel.

FIG. 7 is a block diagram illustrating battery cell arrays electrically connected in parallel and fluidly connected in series.

### DETAILED DESCRIPTION

As required, detailed embodiments of the claimed subject matter are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments of the claimed subject matter.

As described in greater detail herein, a combination electrical and fluid connector according to the disclosure includes embodiments that adapt a common spade or pin type electrical connector to provide fluid flow around the connection point for cooling and fluid transfer between a vehicle cooling system and a battery cell array. The connector is particularly suited for use in applications having the cell arrays electrically and fluidly connected in series, or electrically and fluidly connected in parallel where the cooling fluid runs along the electrical path. Stranded copper wiring of combination cabling is contained within a hose or tubing with the dielectric or electrically non-conductive cooling fluid or coolant. At the end of the tubing, the connector housing or end cap is secured by crimping or an equivalent attachment method. The end cap or connector housing has holes to enable fluid flow from the tube across the connection interface into the receiving connector of the battery cell array. The mating pin or spade may be crimped to the stranded conductor and retained by the connector housing. The connector housing creates a sealed connection with the receiving connector at the array housing, and creates the electrical connection while allowing fluid flow around the electrical connection and into the array housing for immersion cooling of the battery cells. This same connection method may be used at the electric/fluid outlet at the opposite terminal of the battery cell array housing. As the fluid is delivered in contact with the wiring inside the hose or tubing, this design cools the entire length of the electrical wiring between the arrays in addition to the electrical connection points.

In other embodiments, a combination electrical and fluid connector is implemented using a banjo fitting to provide coolant flow internal to the electrical connection point for cooling and fluid transfer into the battery cell array. This embodiment is particularly suited for use in applications having battery cell arrays electrically and fluidly connected in parallel or electrically and fluidly connected in series, in addition to applications that have battery cell arrays electrically connected in series and fluidly connected in parallel, or electrically connected in parallel and fluidly connected in series, as the cooling fluid path can run separately from the electrical path. The banjo connection includes a bolt with an internal fluid channel extending between a radial opening and an open end, and an annular fitting that surrounds the bolt in line with the radial opening to transfer fluid from the tubing or hosing into the bolt channel. The bolt secures an external busbar to the fitting, array housing, and internal busbar. A conductive washer between the busbar and bolt head may be used to provide a fluid seal and electrical conduction. A first or upper washer between the external busbar and fitting, and a second or lower washer between the fitting and the array housing may be used to provide fluid seals. These washers may be conductive or insulating. The array housing and fluid hosing are electrically non-conductive. The current delivery flows from the external bus bar through the conductive washer into the bolt head, and through the bolt to the nut and internal busbar of the array. The cooling fluid is directed through non-conductive hosing to the fitting and into the bolt, directly cooling the electrical connection point, and exits the threaded end of the bolt into the array for immersion cooling of the battery cells. This same connection method may be used at the fluid outlet at the opposite terminal of the battery cell array.

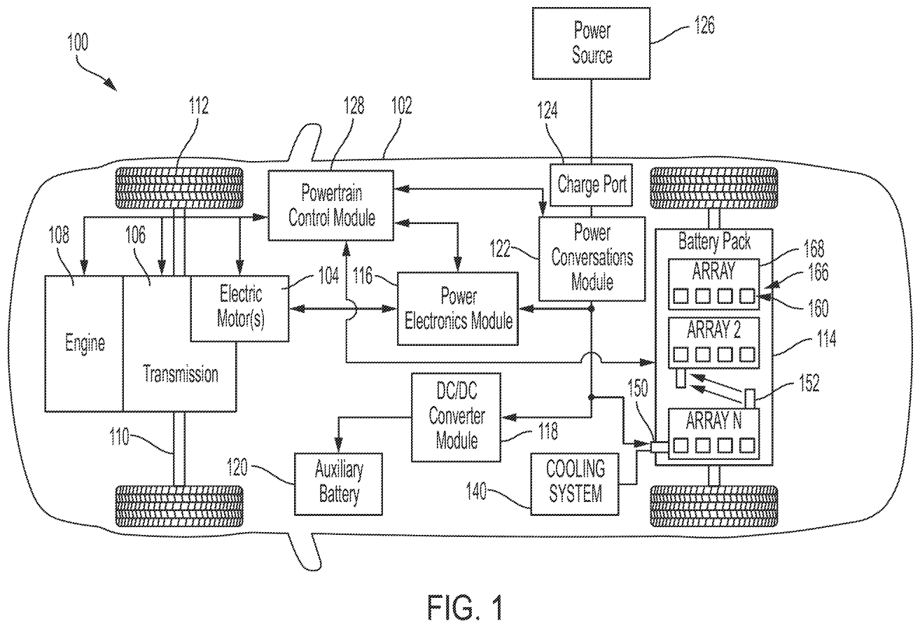

FIG. 1 depicts an example of an electrified vehicle 100 having one or more combination electrical/fluid connectors according to the present disclosure. In this example, electrified vehicle 100 is implemented as a plug-in hybrid-electric vehicle. The electrified vehicle 100 may comprise one or more three-phase electric machines 104 mechanically connected to a transmission 106. Transmission 106 is mechanically connected to an engine 108 for hybrid implementations. The transmission 106 may also be mechanically connected to a drive shaft 110 that is mechanically connected to the wheels 112. The electric machines or motor/generators 104 can provide propulsion whether the engine 108 is turned on or off. One or more electric machines 104 may operate as motors, generators, or both. Electrified vehicle 100 may also be implemented as a battery electric vehicle without an engine 108 and powered solely by traction battery 114 alone or in combination with another power source, such as a fuel cell, for example.

Traction battery or battery pack 114 stores energy that can be used by the electric machines 104. A vehicle battery pack 114 typically provides a high voltage (HV) DC output provided by connecting hundreds of low voltage battery cells 160 together in one or more battery cell modules or arrays 166. Arrays 166 may each be contained within an associated array housing 168 within battery pack 114. Battery cells 160 may be immersed in a dielectric cooling fluid or coolant circulated within a vehicle cooling system 140. Battery cells 160 may be electrically connected by an internal busbar within the associated array housing 168. Arrays may be connected to other arrays by an external busbar outside the array housings but within the battery pack 114. Arrays may be fluidly connected by an inlet combination electrical/fluid connector 150 and outlet combination electrical/fluid connector 152 and associated cabling, hosing, or tubing within battery pack 114. Arrays 166 may be fluidly and electrically connected in series, parallel, or a combination of series and parallel arrangements depending on the particular application and implementation as described in greater detail herein.

The vehicle electrical distribution system (EDS) may also include an HV bus that connects one or more vehicle power modules or components, such as electric machines 104, power electronics module 116, DC/DC converter module 118, etc. as well as an LV bus to battery pack 114. The power electronics module 116 is also electrically connected to the electric machines 104 and provides the ability to bi-directionally transfer energy between the battery pack 114 and the electric machines 104. For example, a typical battery pack 114 may provide a DC voltage/current while the electric machines 104 may require a three-phase AC voltage/current. The power electronics module 116 may include an inverter having a power module with switches operable by a controller to convert the DC power from the battery 114 to a three-phase AC power as required by the electric machines 104. Power electronics module 116 may also include a voltage converter that increases the DC voltage from the battery pack 114 supplied to the HV DC bus that powers the inverter of power electronics module 116. In a regenerative mode, the power electronics module 116 will convert the three-phase AC power from the electric machines 104 acting as generators to DC power required to recapture energy in the battery pack 114. Thermal management of the heat generated by the power conversion is provided by cooling of the power stage assembly module of the power electronics module according to one or more embodiments described herein.

In addition to providing energy for propulsion, the battery pack 114 may provide energy for other vehicle electrical systems. A typical system may include a DC/DC converter module 118 that converts the high voltage DC output of the battery pack 114 to a low voltage DC supply that is compatible with other vehicle loads. Other high voltage loads, such as compressors and electric heaters, may be connected directly to the high-voltage bus from the battery pack 114. In a typical vehicle, the low voltage systems are electrically connected to a 12V, 24V, or 48V battery 120.

The battery pack 114 may be recharged by an external power source 126. The external power source 126 may provide AC or DC power to the vehicle 102 by electrically connecting through a charge port 124. The charge port 124 may be any type of port configured to transfer power from the external power source 126 to the vehicle 102. The charge port 124 may be electrically connected to a power conversion module 122, sometimes referred to as a charger or charging module. The power conversion module may condition the power from the external power source 126 to provide the proper voltage and current levels to the battery pack 114. In some applications, the external power source 126 may be configured to provide the proper voltage and current levels to the battery pack 114 and the power conversion module 122 may not be necessary. The functions of the power conversion module 122 may reside in the external power source 126 in some applications. The vehicle engine, transmission, electric machines, battery, power conversion, power electronics, and various other control modules, components, or systems may be controlled by a powertrain control module (PCM) 128. Alternatively, or in combination, various systems or subsystems may include associated control modules or controllers in communication with PCM 128 over a vehicle wired or wireless network to provide coordinated control of the vehicle. As used in this disclosure, a controller generally refers to one or more control modules or controllers that may cooperate to perform a particular task or function and is not limited to a single controller or any particular dedicated controller or control module.

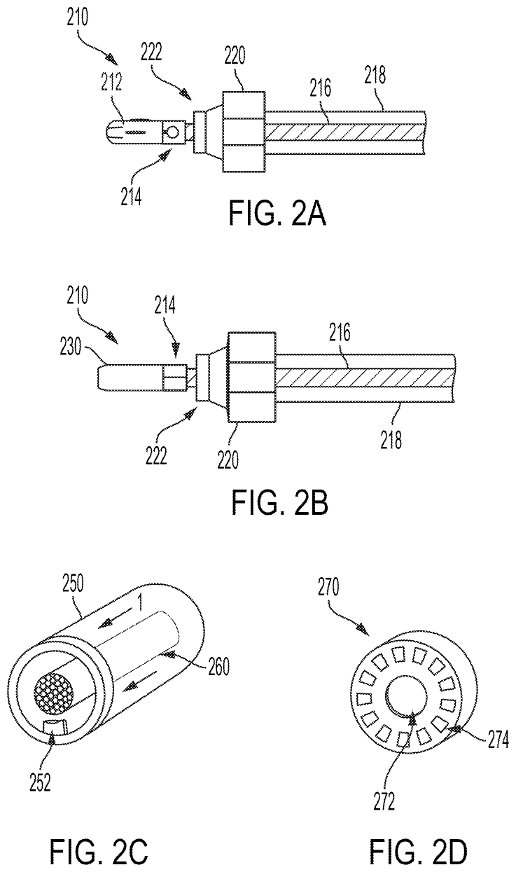

With reference to FIGS. 2A and 2B, a pin connector embodiment and a spade connector embodiment, respectively, of a combination electrical/fluid connector is shown. Connector 210 may include a pin connector 212 or a spade connector 230 coupled at a crimp point 214 to a stranded electrical connector 216. Stranded electrical connector 216 extends from within associated tubing or hosing 218 of a combination electrical/fluid cable through an opening in connector 220, which is crimped to the tubing or hosing 218 to form a fluid seal. Connector 220 may be internally threaded or otherwise configured to connect to a battery cell array housing. After connecting pin 212 or spade 230 to stranded conductor 216, the stranded conductor 216 may be pulled back within hosing 218 to recess the pin/spade connector at least partially within connector 220 to allow coolant flow from hosing or tubing 218 into (or out of) a connected array housing. Alternatively, or in combination, one or more openings may be provided around the central opening to allow coolant flow through the connector as illustrated and described with respect to FIGS. 2C and 2D.

FIGS. 2C and 2D illustrate a combination electrical/fluid cable and associated endcap for an electrical/fluid connector as described with reference to FIGS. 2A and 2B. In one embodiment, a plastic slider 250 contains coolant flowing around a stranded wire conductor 260. The plastic slider 250 may include a retaining feature 252 to secure a pin or spade connector secured to the stranded wire conductor 260 as previously described. An endcap 270 may be secured to plastic slider 250. Endcap 270 includes a central opening 272 configured to accommodate a pin or spade connector, for example. One or more openings 274 may be arranged around the central opening 272 and configured to facilitate coolant flow therethrough.

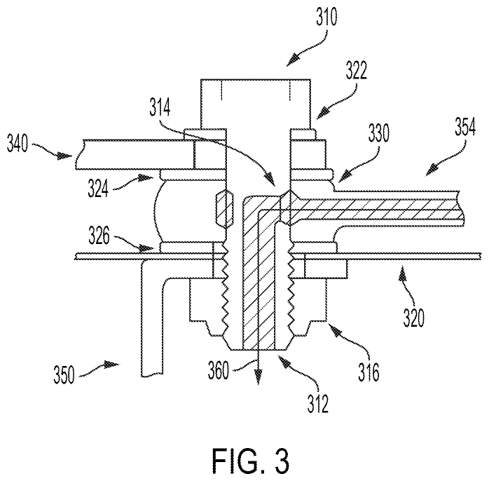

FIG. 3 illustrates a combination electrical/fluid connection of a battery cell array with a banjo fitting. As generally understood by those of ordinary skill in the art and as used herein, a banjo fitting generally refers to a hydraulic fitting having a perforated hollow bolt, or internally relieved bolt, and a spherical union to facilitate fluid transfer through the bolt. Banjo fittings may be used to connect a fluid line to a rigid, internally threaded hydraulic component.

In the embodiment of FIG. 3, a fastener, such as a bolt 310 includes an internal channel extending from an open end 312 to a radial opening 314. In this representative embodiment, bolt 310 provides a mechanical, electrical, and fluid connection to an associated battery cell array by securing an external busbar 340, banjo fitting 330, and internal busbar 350 to an array housing 320. A conductive washer 322 provides a fluid seal and electrical conductivity from external busbar 340 to internal busbar 350 connected to one or more battery cells (not shown). Banjo fitting 330 is an annular fitting that includes a central opening configured to receive bolt 310 and at least one radial opening extending from an outer circumference of the annulus to an inner circumference of the annulus and configured to facilitate flow of a cooling fluid 360 from a connected tube or hose 354. A first or upper washer 324 and second or lower washer 326 may be used to provide a fluid seal. First and second washers 324, 326 may be conductive or insulating depending on the particular application and implementation. Bolt 310 includes a threaded portion extending from open end 312 that engages a complementary threaded nut 316. Bolt 310 is sized such that radial opening 314 is positioned within the annular fitting 330 between a first or upper surface/face of annular fitting 330 in contact with washer 324 and a lower surface/face of annular fitting 330 in contact with lower washer 326.

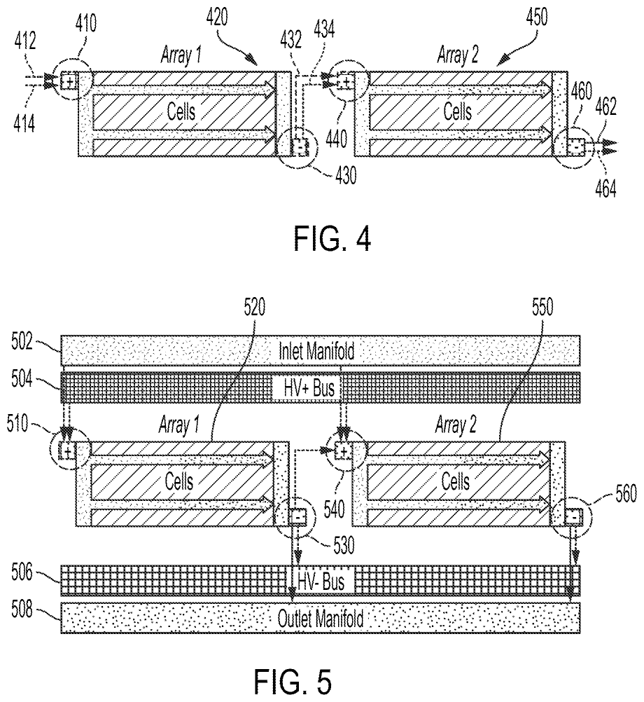

FIG. 4 is a block diagram illustrating battery cell arrays electrically and fluidly connected in series using combination electrical/fluid connectors. A first inlet connector 410 couples a vehicle cooling system to a battery pack via a cooling fluid connection 412 and an electrical connection 414 to a first battery cell array 420. The cooling fluid provides immersion cooling of battery cells contained within a housing of first array 420. Connector 410 connects an external busbar outside of the housing of first array 420 to an internal busbar connected to one or more cells within the housing of first array 420 as previously described. An outlet connector 430 connects cooling fluid within first array 420 to an associated hose or channel coupled to a second inlet connector 440 associated with second battery cell array 450. Similarly, first outlet connector 430 connects the associated internal busbar within first array 420 to an external busbar 434 that is in turn connected to second inlet connector 440 of second array 450. A second outlet connector 460 couples cooling fluid to another array (when present) or to a coolant outlet 462 of the battery and also couples an internal busbar of second array 450 to an external busbar 464 of second array 450.

FIG. 5 is a block diagram illustrating battery cell arrays electrically and fluidly connected in parallel using combination electrical/fluid connectors. In this configuration, a cooling fluid inlet manifold 502 supplies lower temperature coolant to the inlet of at least two battery cell arrays 520, 550 having associated inlet connectors 510, 540, respectively. Similarly, a positive polarity external high voltage (HV) busbar 504 is electrically connected in parallel to input connectors 510, 540 for the battery cell arrays 520, 550. Outlet connectors 530, 560 electrically couple arrays 520, 550 in parallel to a negative polarity external HV busbar 506 and fluidly couple higher temperature cooling fluid exiting arrays 520, 550 in parallel to a coolant outlet manifold 508.

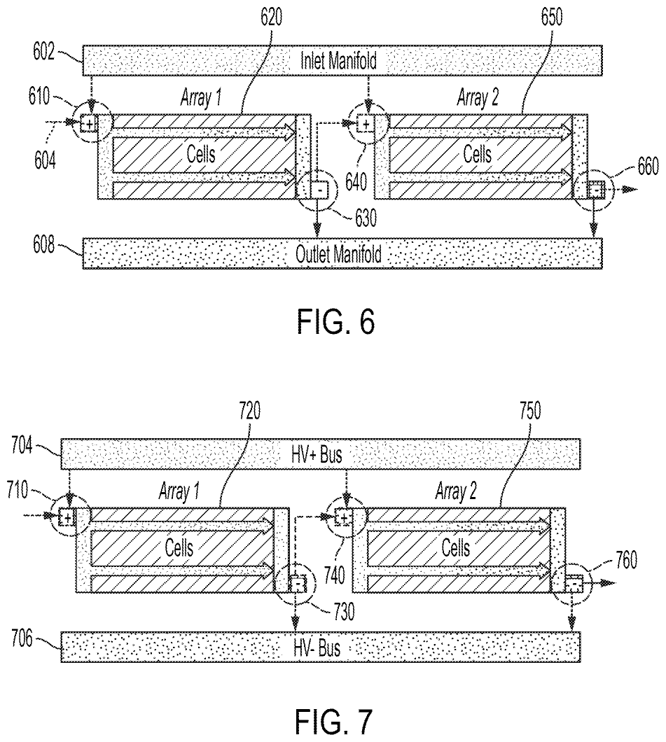

FIG. 6 is a block diagram illustrating battery cell arrays electrically connected in series and fluidly connected in parallel. In this configuration, a cooling fluid inlet manifold 602 supplies lower temperature coolant to the inlet of at least two battery cell arrays 620, 650 having associated inlet or input connectors 610, 640, respectively, and respective outlet or output connectors 630, 660. A positive polarity external busbar 604 is electrically connected to input connector 610. Output connector 630 is fluidly connected to outlet manifold 608, and is electrically connected to internal and external negative polarity busbars, with the external busbar electrically connected in series to input connector 640 and associated positive polarity internal busbar of array 650. Output connector 660 electrically connects the negative internal busbar of array 650 in series to a positive polarity internal busbar of another array, or the negative polarity terminal of the battery pack. Output connector 660 fluidly couples higher temperature cooling fluid exiting array 650 in parallel with cooling fluid exiting array 620 to outlet manifold 608.

FIG. 7 is a block diagram illustrating battery cell arrays electrically connected in parallel and fluidly connected in series. In this configuration, a positive polarity external HV busbar is electrically connected in parallel to positive polarity internal busbars of at least two battery cell arrays 720, 750 via respective input connectors 710, 740. Input connector 710 is fluidly coupled to the vehicle cooling system to provide lower temperature cooling fluid for immersion cooling of cells in array 720. Outlet connectors 730, 760 electrically connect the negative polarity internal busbars of arrays 720, 750, respectively, in parallel to negative polarity external HV busbar 706. Outlet connector 730 fluidly connects cooling fluid from array 720 in series to array 750 via inlet connecter 740. Outlet connector 760 fluidly connects cooling fluid exiting array 750 to another array, or to the vehicle cooling system (not shown).

While representative embodiments are described above, it is not intended that these embodiments describe all possible forms of the invention. The words used in the specification are words of description rather than limitation, and it is understood that various changes may be made without departing from the claimed subject matter. Additionally, the features of various implementing embodiments may be combined to form further embodiments within the scope of the claimed subject matter that are not explicitly described or illustrated.

What is claimed is:

1. An electrified vehicle system, comprising:
a battery having a plurality of cells electrically connected in at least one cell array having an array housing, the at least one cell array connected to an internal battery busbar within the array housing;
an annular coolant fitting having a coolant channel extending between an outer radius and an inner radius of the fitting; and
an electrically conductive fastener having a closed end and a channel extending from an open end to a radial opening, the fastener extending through the annular coolant fitting with the radial opening positioned within the annular coolant fitting, and further extending through the array housing and mechanically and electrically connecting an external busbar outside the array housing to the internal busbar.

2. The electrified vehicle system of claim 1 wherein the fastener comprises a bolt having a threaded region extending below the radial opening and a nut engaging the threaded region, the bolt and nut clamping the external busbar, the annular coolant fitting, and the internal busbar to the array housing.

3. The electrified vehicle system of claim 2 further comprising an electrically conductive washer disposed between the bolt and the external busbar.

4. The electrified vehicle system of claim 3 further comprising an upper washer disposed between the external busbar and the annular coolant fitting and a lower washer disposed between the annular coolant fitting and the array housing.

5. The electrified vehicle system of claim 1 wherein the at least one cell array includes a first cell array and a second cell array and wherein the first and second cell arrays are electrically and fluidly connected in series.

6. The electrified vehicle system of claim 1 wherein the at least one cell array includes a first cell array and a second cell array and wherein the first and second cell arrays are electrically and fluidly connected in parallel.

7. The electrified vehicle system claim 1 wherein the at least one cell array includes a first cell array and a second cell array and wherein the first and second cell arrays are electrically connected in series and fluidly connect in parallel.

8. The electrified vehicle system claim 1 wherein the at least one cell array includes a first cell array and a second cell array and wherein the first and second cell arrays are electrically connected in parallel and fluidly connected in series.

9. An electrified vehicle, comprising:
a traction battery having a plurality of cells connected in each of a plurality of arrays connected by an internal busbar within a housing;
an electric machine powered by the traction battery and configured to provide propulsive torque to vehicle wheels;
a cooling system; and
a connector electrically connecting an external busbar outside the housing to the internal busbar and fluidly connecting the cooling system to at least one of the plurality of arrays of battery cells of the traction battery.

10. The electrified vehicle of claim 9 wherein the connector comprises:
an electrically conductive fastener having a closed end and a channel extending from an open end to a radial opening fluidly coupled to the cooling system, the fastener extending through the housing and mechanically and electrically connecting the external busbar to the internal busbar and fluidly coupling the plurality of arrays to the cooling system.

11. The electrified vehicle of claim 10 further comprising an annular coolant fitting having a coolant channel extending between an outer radius and an inner radius of the fitting, wherein the fastener extends through the annular coolant fitting with the radial opening disposed within the annular coolant fitting.

12. The electrified vehicle of claim 9 wherein the connector comprises:
tubing surrounding a stranded electrical conductor and configured to contain a dielectric coolant;
an end cap connected to the tubing and having a plurality of openings configured to facilitate coolant flow therethrough and a central opening configured to accommodate the stranded electrical conductor;
a threaded fitting secured to the tubing and configured to engage a complementary threaded housing fitting.

13. The electrified vehicle of claim 12 further comprising a spade connector connected to the stranded electrical conductor.

14. The electrified vehicle of claim 12 further comprising a pin connector connected to the stranded electrical conductor.

15. The electrified vehicle of claim 9 wherein the plurality of arrays are either electrically and fluidly connected in parallel, or electrically and fluidly connected in series.

16. The electrified vehicle of claim 9 wherein the plurality of arrays are either electrically connected in series and fluidly connected in parallel, or electrically connected in parallel and fluidly connected in series.

17. A combination electrical and fluid connector, comprising:
an electrically conductive bolt having a closed end, a channel extending from an open end to a radial opening, and a threaded portion extending from the open end toward the radial opening; and
an annular coolant fitting having a coolant channel extending between an outer radius and an inner radius of the fitting, the bolt extending through the annular coolant fitting with the radial opening positioned within the annular coolant fitting, and further extending through a battery cell array housing mechanically and electrically connecting an external busbar outside the housing to an internal busbar within the housing, and facilitating coolant flow through the battery cell array.

18. The connector of claim 17 further comprising a conductive washer disposed between the conductive bolt and the annular coolant fitting.

19. The connector of claim 18 further comprising a threaded nut engaging the threaded portion of the bolt and clamping the external busbar, the annular coolant fitting, and the internal busbar to the housing.

20. The connector of claim 19 further comprising an upper washer disposed between the external busbar and the annular coolant fitting and a lower washer disposed between the annular coolant fitting and the housing.
